(19) United States
(12) Patent Application Publication
(10) Pub. No.: US 2024/0380510 A1
(43) Pub. Date: Nov. 14, 2024

(54) WAVEFORM DETECTION INTERFACE

(71) Applicant: Telefonaktiebolaget LM Ericsson (publ), Stockholm (SE)

(72) Inventor: Christopher RICHARDS, Ottawa (CA)

(21) Appl. No.: 18/689,697

(22) PCT Filed: Aug. 26, 2022
(86) PCT No.: PCT/IB2022/058024

§ 371 Date: Mar. 6, 2024

Related U.S. Application Data
(60) Provisional application No. 63/242,677, filed on Sep. 10, 2021.

(51) Int. Cl. H04K 3/00

(52) U.S. Cl. CPC H04K 3/822; H04K 3/22

(57) ABSTRACT

A method, system and apparatus are disclosed for a waveform detection interface. In one embodiment, a waveform detection interface includes processing circuitry configured to exchange management plane information between a application and the waveform detector, the management plane information including capability information related to waveform detector capabilities. The processing circuitry also exchanges control plane information between the application and the waveform detector, the control plane information including configuration information related to a configuration of the waveform detector. The processing circuitry also exchanges user plane information between the application and the waveform detector.

### TECHNICAL FIELD

The present disclosure relates to wireless communications, and in particular, to a waveform detection interface.

### BACKGROUND

### RF Spectrum:

Radio frequency (RF) wireless spectrum is one of the most tightly regulated communication resources. From the earliest days of wireless communications, regulatory bodies have been concerned about the interference that will be caused by different uses of the wireless spectrum. These concerns lead to the doctrine of assigning blocks of spectrum to specific uses—in other words, dedicating blocks of spectrum to licensee holders. However, with the proliferation of wireless services, much, if not all of the available spectrum has now been fully allocated. On the other hand, several studies have shown that a significant amount of the allocated spectrum is relatively underutilized. This has led to a re-thinking of spectrum policy by national regulators. One promising solution to the spectrum scarcity problem which is gaining considerable momentum is to facilitate spectrum sharing between both use cases (e.g., communications and radar sensing) and technologies (e.g., 3rd Generation Partnership Project (3GPP) and IEEE 802.11).

Sharing the spectrum: Difficulty in moving existing users (incumbents)—leads to a growing desire to share the spectrum.
Relocating existing license holder operations is both expensive, disruptive and time consuming. Sharing spectrum can be an economical alternative to moving existing license holder operations to other spectrum blocks.

Characteristics of incumbents: fixed, known vs mobile, unknown.
There are a number of mechanisms to facilitate spectrum sharing. The mechanisms used depend to a large degree on the nature of the incumbent operations. Broadly, the incumbent operations can be categorized into two groups: (1) fixed known operations, e.g., microwave links, fixed satellite stations, weather radar stations, cellular network base stations and (2), mobile and nomadic operations, e.g., TV broadcast services, military and scientific radar systems.

Types of Spectrum Sharing: database (DB) (e.g., Citizens Broadband Radio Service (CBRS), automatic frequency control (AFC)), dynamic (listen-before-talk (LBT), sensing, dynamic frequency selection (DFS)), etc.
For the first group (fixed known operations), a database mechanism can be used. Users wishing to operate in the spectrum can determine where and what spectrum is in use at any given location. Examples of this mechanism are the 3.5 GHz CBRS and 6 GHz spectrum blocks.
For the second group, the database approach is not sufficient. The incumbents are mobile or nomadic and the frequency ranges that they operate on may change frequently or may be classified. For this group, a sensing mechanism is used such as Listen Before Talk and/or a sensing procedure such as DFS radar detection in 5 GHz.

### Current Relevance of Waveform Sensing:

As stated above, both database and sensing approaches are used to facilitate spectrum sharing.
Regulators are starting programs to quantify the robustness of spectrum sensing to protect mobile military radar operations from communication operations sharing the spectrum. These military and federal operations have large blocks of dedicated spectrum. And it is acknowledged that the spectrum is lightly used and only used in relatively small geographies at any one time. See the following references:
1. United States Federal Communications Commission (FCC) Technology Advisory Committee (TAC) work on Future of Unlicensed Spectrum (2020): further studies and investigations for spectrum sharing was one of the 3 recommendations by the TAC working group to the FCC:
   a. “The FCC should continue its light touch approach to unlicensed spectrum and allow industry to collaborate to determine the best methods for sharing the airwaves. The FCC should avoid further codifying standards in regulation, and allow industry to define technical specifications.”
   b. “However, when requirements and conditions evolve, so should the regulations. In particular, we recommend a rulemaking on personal radars be opened on 60 GHz spectrum where the FCC has received several waiver requests to use the spectrum for personal radar. The FCC needs to move from waivers to rules.”
   c. “Finally, sharing technologies have the potential to unlock large swaths of spectrum for public use. What is clear is that there are many ‘tools in the tool belt’ for sharing spectrum and that there must be careful alignment between technologies, incumbents, and use cases. With several sharing technologies and commercial deployments under development in 2020/2021, further study is needed and the FCC should dedicate a TAC working group to focus on spectrum sharing in 2021.”
2. United States Department of Defense (DoD) program is being considered to lease its spectrum and determine whether it should own and operate a domestic 5G network.
3. Telecommunications Advanced Research and Dynamic Spectrum Sharing Systems (TARDyS3) Tool Suite, Defense Information Systems Agency (DISA): Request for White papers description of project:
   “The Defense Information Systems Agency (DISA), Emerging Technology (EM) Directorate through the DISA Procurement Services Directorate (PSD) is seeking . . . a radically new set of tools to deconflict, manage, and predict spectrum interferences . . . ” . . . “The sum of these tools creates a new paradigm for spectrum sharing between the Department of Defense (DoD) and commercial users that are entering the 3550-3650 megahertz (MHz) spectrum band.”
   “This work is novel and has never been accomplished before within DoD. Thus, innovative solutions will be critical to prototyping and overall acquisition success. The solution must leverage new ideas and concepts to prototype the tools and processes needed to enable near-real time spectrum sharing with industry.”.

Work in the Open Radio Access Network (O-RAN) working group 6 (WG6), Accelerator Abstraction Layer (AAL) includes:
The O-RAN Alliance is developing standards and interface profiles for different accelerator offloading functions. The specific functions that are offloaded are grouped into profiles. For example, currently there is on-going work in O-RAN to define AAL profiles for Upper-PHY offload, forward error correction (FEC) offload as well as other upper-PHY function offload. Discussions also include profiles for cryptographic offload. The goal of the O-RAN AAL work is to enable application vendors and accelerator device vendors to work with an open interface so that applications can be developed to work with multiple accelerator products from a wide variety of vendors, and accelerator vendors can develop products that work with a wide variety of application vendors products. An example of O-RAN is illustrated in FIG. 1.
The O-RAN AAL work is defining a common set of interface operations that are applicable to all accelerator devices—this is termed the “common AAL Profile”. These common AAL operations address actions such as device discovery, device start/stop/reset, device software loading, get logs/faults/capabilities. The profile specific interface operations address actions that are specific to each AAL profile. For example an Upper-PHY profile includes actions to enqueue and dequeue transport blocks.

### Background of Waveforms Sensing:

A waveform pulse is a pulse of RF energy in time and frequency. A pulse may also vary in frequency during the pulse, this is known as a “chirped” pulse.
A waveform is a set of pulses with a specific pattern and timing, i.e. repetition of pulses, pulse burst pattern and duration and interval.

### SUMMARY

Some embodiments advantageously provide methods, systems, and apparatuses for waveform detection interface.

In one embodiment, a network node is configured to receive from an application a request for information related to a waveform detection using an application programming interface (API); and reply to the request with a response that includes the information related to the waveform detection.

In one embodiment, a network node is configured to send from an application a request for information related to a waveform detection using an application programming interface (API); and receive a reply to the request with a response that includes the information related to the waveform detection.

According to one aspect, a waveform detection interface between an application and a waveform detector is provided. The waveform detection interface includes processing circuitry configured to exchange management plane information between the application and the waveform detector, the management plane information including capability information related to waveform detector capabilities. The processing circuitry is further configured to exchange control plane information between the application and the waveform detector, the control plane information including configuration information related to a configuration of the waveform detector. The processing circuitry is also configured to exchange user plane information between the application and the waveform detector.

According to this aspect, in some embodiments, the control plane information includes pulse configuration information to configure the waveform detector to detect a set of at least one pulse characteristic in a signal to be processed by the application. In some embodiments, the at least one pulse characteristic includes at least one of a pulse width, a pulse-chirp frequency range and pulse power. In some embodiments, the control plane information includes waveform configuration information to configure the waveform detector to detect a waveform characteristic. In some embodiments, the waveform characteristic includes at least one of a number of bursts, burst duration and a number of pulses per burst. In some embodiments, the user plane information includes event information concerning at least one of a pulse detection event and a waveform detection event, the event information including an indication of event detection confidence. In some embodiments, the processing circuitry is further configured to perform post-processing of the event information. In some embodiments, the post-processing includes at least one of a correlation of past event information with the event information and machine learning based at least in part on the event information. In some embodiments, the user plane information includes an instruction to invoke the waveform detector. In some embodiments, the user plane information includes I and Q sample information.

According to another aspect, a method in a waveform detection interface The process includes exchanging management plane information between the application and the waveform detector, the management plane information including capability information related to waveform detector capabilities. The process also includes exchanging control plane information between the application and the waveform detector, the control plane information including configuration information related to a configuration of the waveform detector (Block S144). The process further includes exchanging user plane information between the application and the waveform detector.

According to this aspect, in some embodiments, the control plane information includes pulse configuration information to configure the waveform detector to detect a set of at least one pulse characteristic in a signal to be processed by the application. In some embodiments, the at least one pulse characteristic includes at least one of a pulse width, a pulse-chirp frequency range and pulse power. In some embodiments, the control plane information includes waveform configuration information to configure the waveform detector to detect a waveform characteristic. In some embodiments, the waveform characteristic includes at least one of a number of bursts, burst duration and a number of pulses per burst. In some embodiments, the user plane information includes event information concerning at least one of a pulse detection event and a waveform detection event, the event information including an indication of event detection confidence. In some embodiments, the processing circuitry is further configured to perform post-processing of the event information. In some embodiments, the post processing includes at least one of a correlation of past event information with the event information and machine learning based at least in part on the event information. In some embodiments, the user plane information includes an instruction to invoke the waveform detector. In some embodiments, the user plane information includes I and Q sample information.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of O-RAN AAL;

FIG. 2 illustrates an example of 5 GHz U-NII 2 radar detection for use with LTE-license assisted access (LAA);

FIG. 3 illustrates an example of an inline and a lookaside mode of operation according to some embodiments of the present disclosure;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node for radar detection according to some embodiments of the present disclosure;

FIG. 11 is a flowchart of an example process in a network node according to some embodiments of the present disclosure;

FIG. 12 is a flowchart of an example process in a waveform detection interface configured according to principles disclosed herein; and

FIG. 13 is a schematic diagram illustrating an example of O-RAN AAL Common Profile and Common profile operations that may be used in some embodiments of the present disclosure.

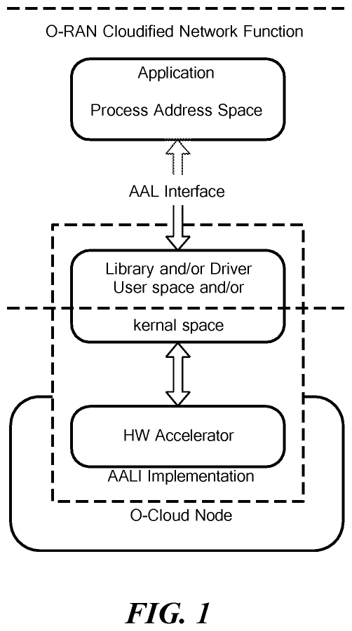

### DETAILED DESCRIPTION

### Waveform Detection:

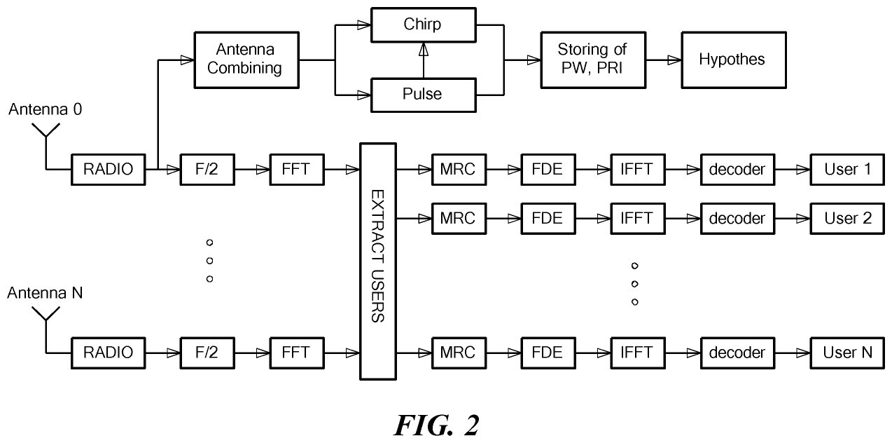

Transmitters that operate in spectrum where waveform detection is used perform waveform detection in the digital domain, e.g., the lower physical layer (PHY) functions.
1. The radio unit (RU) performs reception of analogue RF and converts the received RF energy to digital format samples using an Analogue to Digital Convertor (ADC).
2. The digital uplink (UL) samples are sent as a data stream to the physical layer (PHY) function for processing and demodulation. The data stream may be in an IQ format for use with fronthaul (FH) interfaces such as 3GPP lower layer split option 7 or 8 or Ericsson C1 or C2 splits and ORAN LLS.
3. Before PHY function processing, the waveform detection function may use digital signal processing algorithms to search for waveform pulse signatures in the uplink (UL) in phase (I) and quadrature (Q) data stream. The pulse signatures may be based on received RF power, pulse width in frequency and time and/or pulse frequency change (chirp).
4. Once a possible waveform pulse has been identified, the next step is to match the pulse against a set of known waveforms (e.g., patterns). This may be done by matching received pulses to waveform pulse intervals, pulse repetitions and pulse patterns. If the received pulses are a “good” match to one or more of the known waveforms, a waveform detected event can be declared, which may trigger further actions including ceasing transmission on the frequencies on which the waveform signal was received. For example, one vendor has implemented the following for radar detection in the 5 GHz U-NII 2 band:
5 GHZ U-NII 2 radar detection in 2019 for use with 3GPP Long Term Evolution License-Assisted Access (LTE-LAA). It allows operation in restricted parts of the 5 GHz band. Radar detection is implemented within the lower PHY distributed unit (DU) software (SW). It operates as a lookaside function so that a copy of the uplink IQ samples is sent to the radar detection function allowing the normal processing of UL to execute in parallel, as shown in FIG. 2, for example.
The pulse and chirp detection functions are executed on a digital signal processing (DSP) hardware resource with HW acceleration for specific tasks needed for chirp detection.
The vendor's radar detection function is programmed to detect the radar waveforms required by the FCC for the U-NII 2 band and those required by ETSI for the 5 GHz band.

The waveform detection function HW or SW may be integrated with the communication functions or realized in separate specialized detection nodes.
A waveform detection device may be realized as a hardware (HW) device, as a software (SW) executed by a processor or a combination of both HW and SW.

The term radar detection function and Radar Detection device may be used interchangeably. A waveform detection function may provide multiple waveform detection services to an application. HW used for waveform detection may serve multiple applications.

Some embodiments provide arrangements related to defining a set of application programming interfaces (APIs) for waveform detection.

Without a defined interface between an application and waveform detection functions, each application implementation and each waveform detection implementation would require specific implementation in both the application and waveform detection function. There is no existing defined separation of the application from the waveform detection function. There is no possibility of re-use of the waveform detection function across applications. There is limited possibility of re-use of the application with multiple waveform detection functions.

Because of the increased focus of spectrum sharing with radar systems, radar detection capabilities may receive increased attention from the industry. Some embodiments use, for example, O-RAN WG6 AAL to define a set of APIs for radar detection acceleration (application offload).

Some embodiments define an interface set of operations that may be used between application functions, e.g., wireless base station baseband or radio units' digital functions, and a waveform detection function, e.g., radar detection function.

Some embodiments describe the information and data exchanged over the interface to enable a wide range of novel waveform detection function capabilities.

Some embodiments include defining an interface and the data that is exchanged between an application (e.g., 3GPP New Radio (NR, also called 5G or 5th Generation) baseband application) and a waveform detection function (for example a radar detection function).

Some embodiments of the interface can be used in various operating models (inline, lookaside) and different radio access network (RAN) architectures, e.g., 3GPP option 7 lower layer split (LLS), O-RAN LLS, proprietary LLS as well as other 3GPP RAN architecture options.

Some embodiments of the interface operations can be included in O-RAN WG6 AAL standards as a new O-RAN AAL profile for waveform detection or more specifically for incumbent radar detection.

Some embodiments of the interface may have one or more benefits including:

### Clarity

Having a clear interface between applications and waveform detection functions allows for re-use, clean separation of functions, multi-vendor implementations, multiple waveform detection functions to be applied. Use of a single waveform detection function by multiple applications, allows changing waveform detection implementations without changing the applications.

### Separation and Independence of Physical Network Function HW

Some embodiments of the waveform detection interface can allow partners to develop waveform detection implementations for integration with certain vendor products by releasing an interface specification.

Some embodiments may be applicable to any wireless communication technology that can operate in a shared spectrum where detection of near real-time incumbent transmissions (e.g., radar) is required, including 3GPP LTE and NR, Institute of Electrical and Electronics Engineers (IEEE) 802.11 Wi-Fi and proprietary derivatives.

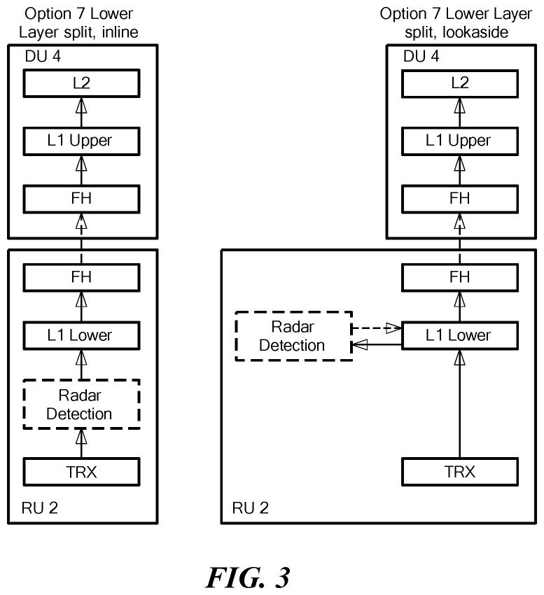

Some embodiments may provide one or more of the following:
1. Definition of a flexible waveform detection interface between applications e.g., base station lower PHY and/or the TRX transport protocol (e.g., common public radio interface (CPRI) C1) functions and a waveform detection function, e.g., radar detection function, performed by a waveform detector. A pulse/waveform detection function may be capable of detecting many different types of RF transmissions including radar transmissions, IEEE 802.11 Wi-Fi transmissions and 3GPP LTE or NR transmissions. The waveform detection interface may be specified to provide flexibility for all pulse/waveform detection use cases. In some embodiments, a base station may provide the application and a radar detection (RD) unit may serve as the waveform detector. However, use of the waveform detection interface does not preclude other waveform detection use cases, e.g., to detect transmissions from microwave backhaul equipment or Wi-Fi access points.
2. Some embodiments may include one or more of the following:
   a) The interface definition covering management plane (MP), control plane (CP), User plane (UP).
   b) The waveform detection interface supporting both inline and lookaside modes of operation by the application. See FIG. 3, which provides an example comparison of an inline arrangement and a lookaside arrangement for waveform detection. In FIG. 3, the radio unit (RU) 2 performs the application function and the distributed unit (DU) 4 performs the waveform detection function.
   c) The waveform detection interface allowing the waveform detection function to be:
      I. Integrated within the base station HW, e.g., using the HW resources part of the base station application;
      II. A separate HW device within the base station platform, e.g., a peripheral component interconnect express (PCIe) card installed in a commercial over the shelf (COTS) compute server platform; and/or
      III. A separate network node communicating with the base station over a transport network, e.g., a dedicated RD platform connected through an Internet Protocol (IP) network.
   d) The waveform detection interface allowing for pre-configured radar pulses and waveforms as well as user configured radar pulses and waveforms to be detected.
   e) The waveform detection interface allowing for notification of detected radar pulses and/radar waveforms.
   f) The waveform detection interface allowing for indication of a radar waveform false detection probability.
   g) The waveform detection interface allowing for inputting detected waveform post processing analysis (in order to improve future pulse and waveform detection).
   h) The waveform detection interface allowing for user configuration of pulse and waveform types to be detected.
   i) The ability of the RD function to override user input detection power threshold(s) in order to ensure compliance with regulatory requirements.
3. Definition of an O-RAN AAL profile for radar detection based upon the waveform detection interface for inclusion in O-RAN standards (AAL standards).
4. Definition of the outline for an O-RAN AAL interface for radar detection based upon the waveform detection interface for inclusion in O-RAN standards (AAL standards).

Some embodiments may advantageously provide for a well-defined pulse/waveform detection interface that provides a separation of functions which enables the application functions and waveform detection functions to be implemented independently, e.g., by different vendors and realized on different HW and SW environments.

### For Base Station Vendors:

Some embodiments enable a waveform detection function to be developed once and re-used across different base station platforms or wireless technologies or base station HW or 3GPP generations with minimal impact to the base station applications or waveform detection function.
Some embodiments allow base station development to proceed without impacting the waveform detection function or implementation.
Some embodiments allow waveform detection functions from multiple waveform detection vendors to be integrated with the base station applications/products.

For vendors of waveform detection functions, e.g., a radar detection accelerator devices:
Some embodiments enable radar detection vendors to develop a single implementation of the radar detection function to be usable across different vendor applications. One product can be used by many applications and application vendors products.

In some embodiments, the interface design allows for the waveform detection function to be configured with new waveform pulse and waveform types that are not included in the base RD function. Some embodiments provide for enhancing the RD function detection accuracy by enabling external analysis of detected waveforms to be fed back into the RD function in order to improve future detection accuracy.

Before describing in detail example embodiments, it is noted that the embodiments reside primarily in combinations of apparatus components and processing steps related to waveform detection interface. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled.” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD. Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As used herein, an application programming interface (API), or a waveform detection interface refers to an interface between a waveform detector and an application that requires waveform detection information from the waveform detector. The interface functions to enable communications between the waveform detector having a first communications protocol and first set of functionalities and the application having a second communications protocol and second set of functionalities.

Some embodiments provide arrangements for a waveform detection interface.

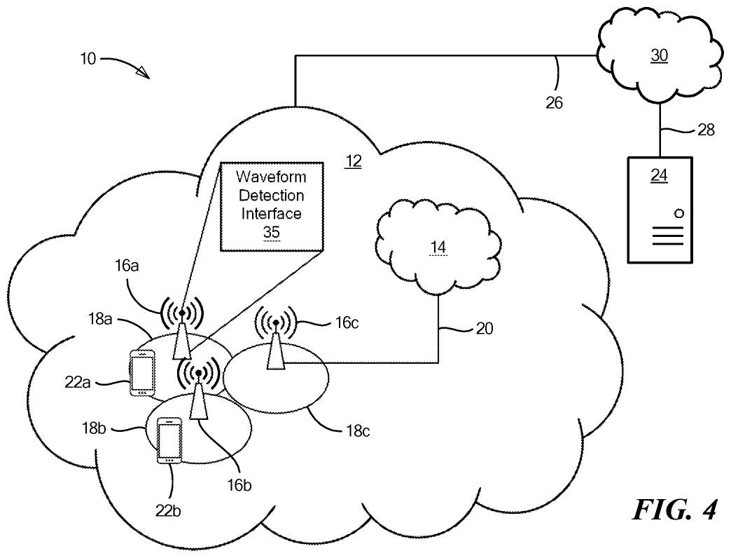

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a. 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

In some embodiments, one or more of the network nodes 16 may include a lower layer split architecture that includes a radar detection function disclosed herein that can be accessed via a set of API functions, request/responses, procedures, parameters, etc. In some embodiments, the radar detection function may be disposed in an inline or lookaside arrangement relative to one or more of the split network node functions.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 may be configured to include a waveform detector 32 which is configured to receive from an application a request for information related to a waveform detection using an application programming interface (API); and reply to the request with a response that includes the information related to the waveform detection. The network node 16 configured to include an application 34 which is configured to receive from an waveform detection interface 35 a request for information related to a waveform detection; and reply to the request with a response that includes the information related to the waveform detection. The network node 16 may include an waveform detection interface 35 configured to communicatively interface between the waveform detector 32 and the application 34. In some embodiments, the waveform detection interface 35 is configured to exchange management plane, control plane and user plane information between the waveform detector 32 and the application 34.

In one embodiment, a waveform detection interface 35 is configured to send from an application 34 a request for information related to a waveform detection by the waveform detector 32, the waveform detection interface 35 operating as an application programming interface (API); and receive a reply to the request with a response that includes the information related to the waveform detection.

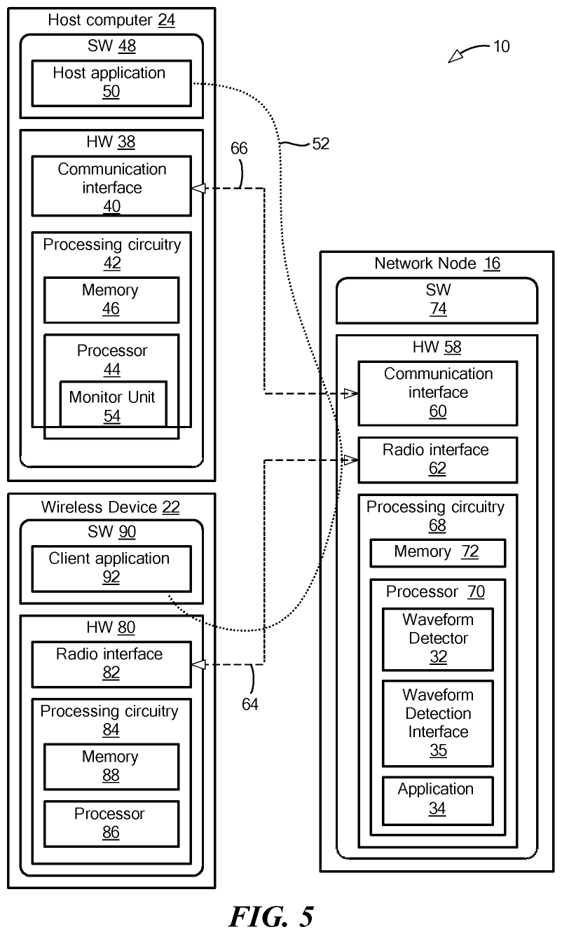

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to monitor the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

For example, processing circuitry 68 and/or radio interface 62 and/or communication interface 60 of the network node 16 may include waveform detector 32 configured to receive from an application 34 via the waveform detection interface 35, a request for information related to a waveform detection; and reply to the request with a response that includes the information related to the waveform detection.

In some embodiments, the processing circuitry 68 and/or radio interface 62 and/or communication interface 60 of the network node 16 may include waveform detector 32 configured to send from an application a request for information related to a waveform detection using an application programming interface (API); and receive a reply to the request with a response that includes the information related to the waveform detection.

In some embodiments, waveform detector 32 and application 34 may both be included in the hardware 58 of the network node 16, as illustrated in FIG. 5 for example.

In some embodiments, waveform detector 32 and application 34 may be included in separate network nodes 16, and the waveform detection interface 35 may be placed in either of the separate network nodes, and the separate network node and may be connected by, e.g., a transport network.

In some embodiments, waveform detector 32 and application 34 may be on a same platform on e.g., a same board or rack, but on different PCIs. The waveform detection interface 35 may be on the same or different board or rack as the detector unit.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as waveform detector 32, and application 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

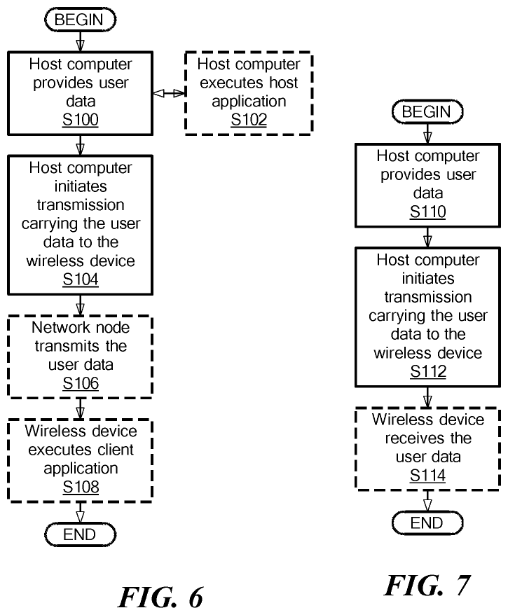

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

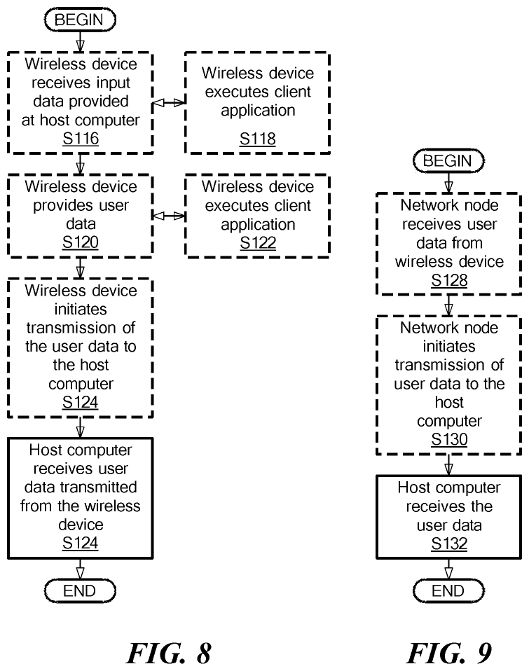

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

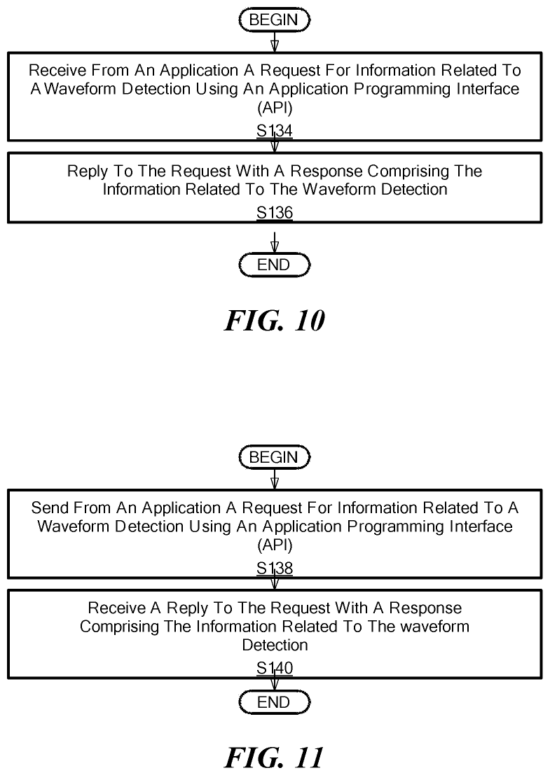

FIG. 10 is a flowchart of an example process in a network node 16 for providing an API. One or more blocks described herein may be performed by one or more elements of network node 16 such as by one or more of processing circuitry 68 (including the waveform detector 32), processor 70, radio interface 62 and/or communication interface 60. Network node 16 such as via processing circuitry 68 and/or processor 70 and/or radio interface 62 and/or communication interface 60 is configured to receive (Block S134) from an application a request for information related to a waveform detection using an application programming interface (API). Network node 16 such as via processing circuitry 68 and/or processor 70 and/or radio interface 62 and/or communication interface 60 is configured to reply (Block S136) to the request with a response comprising the information related to the waveform detection.

In some embodiments, network node 16 such as via processing circuitry 68 and/or processor 70 and/or radio interface 62 and/or communication interface 60 is configured to detect a radar transmission and provide the information related to the radar detection to the application using the API; detect a Wi-Fi transmission and provide the information related to the Wi-Fi waveform detection to the application using the API; and/or detect a 3GPP LTE/NR transmission and provide the information related to the 3GPP LTE/NR waveform detection to the application using the API.

In some embodiments, the network node 16 is, or includes, or is included in a base station/radio access network. The application 34 that uses the waveform detection interface 35 includes at least one of a radio TRX function, a baseband processing function (BPF), a radio unit (RU), a distributed unit (DU) and a digital L1 lower PHY function comprised in a base station/radio access network.

In some embodiments, the request comprises a management plane (MP) request that may request one or more of the following: a request to configure the waveform detection operational mode as one of inline and lookaside operation as depicted in FIG. 3; a request to receive a report of waveform detection capabilities; and a request to receive a list of predefined identifiers for pulse and/or waveform types detectable by the network node.

In some embodiments, the request includes a control plane (CP) request to configure and/or receive from the network node waveform parameters comprising at least one of a power threshold value, pulse and/or chirp characteristics, pulse meta data, event data and a detection probability value. The CP request may include a request and/or a response that indicates at least one of: a predefined identifier of a pulse and/or a waveform type, a trigger detection event, a timestamp for the detection, a detection event notification and an identifier of a type of waveform analysis.

In some embodiments, the request includes a user plane (UP) request that requests an IQ sample.

FIG. 11 is a flowchart of an example process in a network node 16 for using an API according to some embodiments. One or more blocks described herein may be performed by one or more elements of network node 16 such as by one or more of processing circuitry 68 (including the waveform detection interface 35), processor 70, radio interface 62 and/or communication interface 60. Network node 16 such as via processing circuitry 68 and/or processor 70 and/or radio interface 62 and/or communication interface 60 is configured to send (Block S138) from an application a request for information related to a waveform detection using an application programming interface (API) (waveform detection interface 35). Network node 16 such as via processing circuitry 68 and/or processor 70 and/or radio interface 62 and/or communication interface 60 is configured to receive (Block S140) a reply to the request with a response comprising the information related to the waveform detection.

In some embodiments, network node 16 such as via processing circuitry 68 and/or processor 70 and/or radio interface 62 and/or communication interface 60 is configured to determine whether to cease, start and/or continue transmission on frequencies that the waveform is detected on.

In some embodiments, the analog radio unit (RU) 2 performs reception of analog RF, and converts the received RF energy to digital format samples using an Analogue to Digital Convertor (ADC). An application 34 associated with the analog RU sends a first request to the waveform detector 32 comprising the digital format samples (e.g., IQ format). The waveform detector 32 may perform one or more of the following waveform detection functionality: digital signal processing to search for waveform pulse signatures in the UL IQ data stream; when a possible waveform pulse has been identified the waveform detector 32, matching the pulse against a set of predefined waveform (patterns) and if there is a match (e.g., based on a threshold), then triggering a waveform detection event; and as a result of the waveform detection event being triggered, waveform functionality may include sending information about the detected waveform to an L1 lower PHY layer application, which may include application 34. As a result of the indicated information, the L1 lower PHY layer application may determine whether to cease, start and/or continue transmission on frequencies that the waveform is detected on and report that toward the L1 upper PHY layer.

In some embodiments, such as a lookaside arrangement shown in FIG. 3, the analog RU 2 sends the digital format samples to the L1 lower PHY layer application, which includes application 34, (instead of the waveform detector 32), and the L1 lower PHY layer application may forward the digital format samples to the waveform detector 32 to perform the waveform detection functionality.

In some embodiments, information included in the response is related to a radar detection. In some embodiments, information included in the response is related to a Wi-Fi waveform detection. In some embodiments, information included in the response is related to a 3GPP LTE/NR waveform detection.

In some embodiments, the network node is included in a base station/radio access network, and the application using the waveform detection interface 35 includes at least one of a radio TRX function, a baseband processing function (BPF), a radio unit (RU). The network node may also include a digital L1 lower PHY function. The network node may also include a distributed unit (DU) where the waveform detection interface 35 may be located.

In some embodiments, the request comprises a management plane (MP) request that may include one or more of: requesting to configure the waveform detection operational mode as one of inline and lookaside operation; requesting to receive a report of waveform detection capabilities; and/or requesting to receive a list of predefined identifiers for pulse and/or waveform types detectable by the network node.

In some embodiments, the request includes a control plane (CP) request that requests to configure and/or receive from the network node waveform parameters including at least one of a power threshold value, pulse and/or chirp characteristics, pulse meta data, event data and a detection probability value. In some embodiments, the request and/or the response indicates at least one of: a predefined identifier of a pulse and/or a waveform type, a trigger detection event, a timestamp for the detection, a detection event notification and an identifier of a type of waveform analysis.

In some embodiments, the request includes a user plane (UP) request that requests an IQ sample.

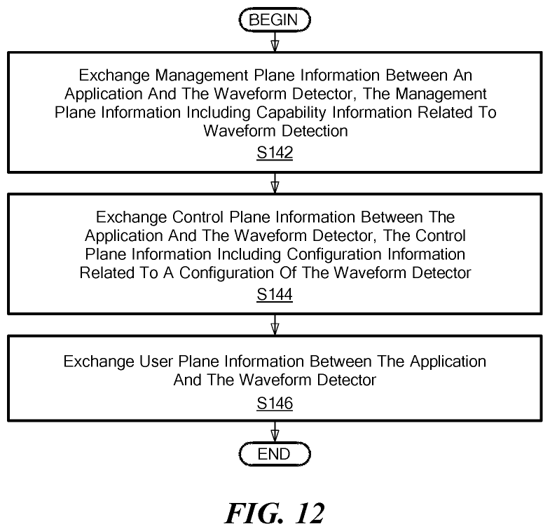

FIG. 12 is a flowchart of an example process in a waveform detection interface 35 that may be implemented in a network node 16, including by processing circuitry 68, the waveform interface 35 being configured to interface between the waveform detector 32 and the application 34. The process includes exchanging management plane information between the application and the waveform detection function, the management plane information including capability information related to waveform detection function capabilities (Block S142). The process also includes exchanging control plane information between the application and the waveform detection function, the control plane information including configuration information related to a configuration of the waveform detection function (Block S144). The process further includes exchanging user plane information between the application and the waveform detection function (Block S146).

In some embodiments, the control plane information includes pulse configuration information to configure the waveform detection function to detect a set of at least one pulse characteristic in a signal to be processed by the application. In some embodiments, the at least one pulse characteristic includes at least one of a pulse width, a pulse-chirp frequency range and pulse power. In some embodiments, the control plane information includes waveform configuration information to configure the waveform detection function to detect a waveform characteristic. In some embodiments, the waveform characteristic includes at least one of a number of bursts, burst duration and a number of pulses per burst. In some embodiments, the user plane information includes event information concerning at least one of a pulse detection event and a waveform detection event, the event information including an indication of event detection confidence. In some embodiments, the processing circuitry is further configured to perform post-processing of the event information. In some embodiments, the post processing includes at least one of a correlation of past event information with the event information and machine learning based on the event information. In some embodiments, the user plane information includes an instruction to invoke the waveform detection function. In some embodiments, the user plane information includes I and Q sample information.

Having described the general process flow of arrangements of the disclosure and having provided examples of hardware and software arrangements for implementing the processes and functions of the disclosure, the sections below provide details and examples of arrangements for waveform detection interface, which may be implemented by network node (NN) 16 such as via waveform detector 32 (which may provide the waveform detection functionality), application 34 (which may implement an application's use of the waveform detection functionality), radio interface 62, communication interface 60, processing circuitry 68, etc. or any of the other HW/SW elements described herein.

Some embodiments provide arrangements to define a waveform detection interface 35 that can be used in, for example, various RAN architectures including for example Lower Layer Split, PHY-RF split, etc. The waveform detection interface 35 may be used in architectures where there is no exposed interface between digital PHY and radio functions. Embodiment 1b.

In some embodiments, the waveform detection interface 35 can be used to detect a wide variety of RF waveforms, including radar waveforms, IEEE 802.11 Wi-Fi waveforms, 3GPP LTE and NR waveforms. In some embodiments, the waveform detection interface 35 covers the management, control and/or user plane interface parts. In some embodiments, the application 34 described in the examples below may be the Radio TRX function/TRX transport protocol function or lower PHY function, which are non-limiting examples of functions that may utilize the waveform detection APIs disclosed herein.

### Management Plane (MP):

As well as existing operations to discover, initialize, start, stop, reset or load the waveform detector 32, etc., the waveform detector 32 may be configured to report other capabilities and information to the application 34 that is utilizing the waveform detector services, such as its certified SW or firmware version, certified configurations and certification identification details. Example information and parameters exchanged over the waveform detection interface 35 are given below. Embodiments 1a and 1c.

| Waveform Detection | Example | |
|---|---|---|
| Interface | Parameters | API Description |
| CONFIG_WAVEFORM_{—} | IQ Return Boolean; | Configure operational |
| DETECTOR_DEVICE_OPMODE | IQ_sample_format; | mode: IQ copy or return |
| | Operating | IQ_Return = False: RD |
| | jurisdiction; | device is working on a |
| | Frequency band | copy of the IQ so does not |
| | | need to return it to the |
| | | application, e.g., for |
| | | lookaside operation. |
| | | IQ_Return = True: RD |
| | | device must pass the |
| | | unaltered IQ data back to |
| | | the application after it has |
| | | completed processing it, |
| | | e.g., for inline operation |
| GET_WAVEFORM_DETECTOR_{—} | Struct . . . | This may include a list of |
| DEVICE_CAPABILITIES | | capabilities that the RD |
| | | device offers including |
| | | supported jurisdictions, |
| | | ability to define custom |
| | | pulse and radar waveform |
| | | types, the list of built-in |
| | | pulse and waveform types |
| | | and other operating |
| | | modes. |
| Get_list_of_pulse_ids | None | List of pulse_ids and |
| Get_list_of_waveform_types | | whether each is enabled or |
| | | disabled for detection. |
| | | Same for waveform_types |

### Control Plane (CP):

Some embodiments provide arrangements for control Plane (CP) data exchange to configure waveform parameters in the waveform detector 32, including power threshold(s) (dBm), pulse and chirp characteristics in terms, of pulse width (time), pulse width (frequency), frequency change, pulse repetition, pulse burst characteristics, e.g., number of pulses in a burst, burst duration, etc. Embodiments 1d and 1h.

Some embodiments provide arrangements for data exchange for the application 34 to receive pulse meta data (for correlation of detected pulses or training of machine learning/AI algorithms), partial detection meta data, full event detection meta data. The meta data may be in the format of a list of pulse or burst events, each timestamped and containing the characterization of the event, e.g., pulse width, power, frequency change, etc., including a detection probability assigned by the waveform detection function. Embodiments 1e and 1f. Some embodiments may include one or more of the following:
a) In the case of lower layer split base station implementations, as shown in FIG. 3, an event handling function of the radio unit (RU) 2 uses the waveform detection interface 35 to retrieve event data from the waveform detector 32/and/or
b) In non-Lower layer split base station implementations, an event handling function of the distributed unit (DU) 4 uses the waveform detection interface 35 to retrieve event data from the waveform detector 32.

Some embodiments provide arrangements for data exchange to enable input of post processing analysis of previously detected (radar) pulses and/or waveforms.

### Embodiment 1g

### Control Plane Interface Data Exchanges:

| Waveform Detection | Example | |
|---|---|---|
| Interface | Parameters | API Description |
| Configure_custom_{—} | Pulse_id, struct | Configure a custom pulse |
| waveform_pulse_type | pulse_details | Pulse_details (pulse_width |
| DeConfigure_custom_{—} | returns ERROR when | (us), pulse-Chirp_width |
| waveform_pulse_type | trying to de-configure | (Hz)) |
| | a built-in pulse_id | |
| Configure_custom_{—} | pulse_id, | Build a custom waveform |
| waveform_type | waveform_definition | to detect based upon |
| Configure_custom_{—} | Returns | defined pulse_id types or |
| waveform_type | waveform_type_id or | built-in pulse types and |
| | ERROR | the burst and |
| | | characteristics of the |
| | | waveform |
| | | Waveform_definition |
| | | (PRI, |
| | | num_pulses_per_burst, |
| | | num_bursts) |
| Enable_waveform_{—} | waveform_type_id, | Instruct RD device to |
| type_detection | detection_threshold | trigger a detection event |
| Disable_waveform_{—} | (dBm) | for the configured |
| type_detection | | waveform. The |
| | | waveform_type_id may be |
| | | pre-defined by the |
| | | waveform detector device |
| | | or maybe a custom |
| | | waveform defined with |
| | | Configure_custom_waveform_type |
| | | API. |
| Enable_pulse_type_{—} | Pulse_id, | Instruct waveform |
| detection | detection_threshold | detector device to trigger a |
| Disable_pulse_type_{—} | (dBm) | detection event for the |
| detection | | configured waveform. The |
| | | pulse_id may be pre- |
| | | defined by the waveform |
| | | detector device or maybe |
| | | a custom pulse defined |
| | | with |
| | | Configure_custom_pulse_type |
| | | API. |
| Pulse_detection_event_{—} | pulse_id, timestamp, | Pulse details include |
| notification | pulse_details | power (dBm), pulse_width |
| | | (us), pulse-Chirp_width |
| | | (Hz) |
| Waveform_detection_{—} | waveform_type, | Waveform_Details |
| event_notification | start_timestamp, | include, number of pulses, |
| | duration, | list of the detected |
| | waveform_details, | pulse_details, |
| | false_probability_estimate, | Unique_id (can be used |
| | waveform_unique_id | for ML feedback) |
| waveform_analysis_result | waveform_unique_id, | Used for providing post |
| | waveform_analysis | processing analysis to the |
| | | waveform detector |
| | | function of a previously |
| | | detected waveform by the |
| | | waveform detector |
| | | function. For example post |
| | | processing may use multi |
| | | site correlation or analysis |
| | | by a ML algorithm. This |
| | | input allows the waveform |
| | | detector to improve its |
| | | waveform detection |
| | | algorithms to reduce false |
| | | detections/increase true |
| | | detection probability. |

### User Plane (UP):

Some embodiments provide arrangements for UP “Enqueue” interface operations to pass UL samples, such as IQ samples, to the waveform detector 32 for processing and analysis. The enqueue operations may be the same in each of the following 3 clauses. However, in some embodiments, the function that invokes the operations may be different. Embodiment 1b. Some embodiments may include one or more of the following:
1. In cases of lower layer split base station implementations where the waveform detector function performed by the waveform detector 32 is performed inline, the UL samples/IQ are received from the Radio TRX function and passed to the waveform detector function by invoking the waveform detector function enqueue UP operation. The waveform detector 32 can then process the samples/IQ;
2. In cases of non-lower layer split base station implementations where the waveform detector function performed by the waveform detector 32 is performed inline, the UL samples/IQ are received from the DU forward haul (FH) function and passed to the waveform detector function by invoking the waveform detector function enqueue UP operation. The waveform detector 32 can then process the samples/IQ; and/or
3. In cases where the waveform detector function is performed using the lookaside mode of operation on either lower layer split or non-lower layer split base station implementations, the lower PHY function invokes (e.g., via application 34) the waveform detector function enqueue UP operation. The waveform detector 32 can then process the samples/IQ.

Some embodiments provide arrangements for UP “dequeue” interface operations to retrieve UL samples/IQ from the waveform detector 32. Embodiment 1b.
c) In cases where the waveform detector function is performed using in inline mode of operation (IQ_RETURN=TRUE), the lower PHY function (e.g., application 34) may invoke the waveform detector function dequeue UP operation to retrieve the samples/IQ from the waveform detector function (e.g., waveform detector 32) and continue processing the samples/IQ.

### User Plane Example Interface Operations

| Radar Detection API | Example Parameters | API Description |
|---|---|---|
| ENQUEUE_IQ_WAVE | Pointer to list of (IQ) | API for application to |
| FORM_DETECTION | samples, | enqueue IQ samples to |
| | Number_of_IQ_samples | the waveform detector |
| | Returns | device for processing. |
| | Number_of_IQ_samples | Each (IQ) sample |
| | enqueued | includes a timestamp |
| | | when the sample was |
| | | received, power, |
| | | frequency sampling rate, |
| | | etc. |
| ENQUEUE_IQ_WAVE | Pointer to list of IQ | API for application to |
| FORM_DETECTION | samples, Returns | dequeue IQ samples from |
| | Number_of_IQ_samples_{—} | the waveform detector |
| | dequeued, ERROR if | device. Only used if |
| | IQ_Return = FALSE | IQ_Return = True. |
| | | Each IQ_sample includes |
| | | a timestamp when the |
| | | sample was originally |
| | | received. |
| | | The application may poll |
| | | the UP output queue or |
| | | the waveform detector |
| | | device may generate an |
| | | interrupt for the |
| | | application when there |
| | | are objects ready for |
| | | dequeuing. |

### O-RAN Alliance Accelerator Abstraction Layer Profile

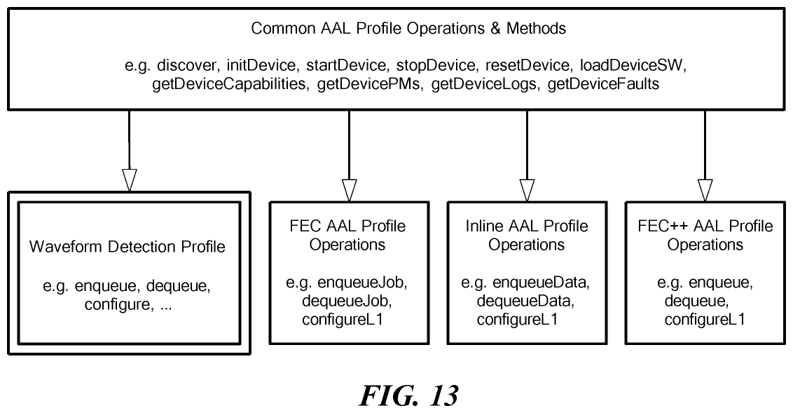

In some embodiments, the waveform detector profile may be defined at the same level as the current O-RAN AAL profiles. It may inherit the O-RAN AAL Common Profile and Common profile operations, an example of which is shown in FIG. 13.

Some examples may include one or more of the following:

Example A1. A network node configured to communicate with a wireless device (WD) and to provide an application programming interface (API), the network node configured to, and/or comprising a radio interface, a communication interface and/or comprising processing circuitry configured to:
receive from an application a request for information related to a waveform detection using an application programming interface (API); and
reply to the request with a response comprising the information related to the waveform detection.

### Some Further Examples Include:

Example A2. The network node of Example A1, wherein the network node and/or the radio interface and/or the communication interface and/or the processing circuitry is configured to:
detect a radar transmission and provide the information related to the radar detection to the application using the API;
detect a Wi-Fi transmission and provide the information related to the Wi-Fi waveform detection to the application using the API; and/or
detect a 3GPP LTE/NR transmission and provide the information related to the 3GPP LTE/NR waveform detection to the application using the API.

Example A3. The network node of any one of Examples A1 and A2, wherein one or more of:
the network node is comprised in a base station/radio access network; and
the application using the API comprises at least one of a radio TRX function, a baseband processing function (BPF), a radio unit (RU), a distributed unit (DU) and a digital L1 lower PHY function comprised in a base station/radio access network.

Example A4. The network node of any one of Examples A1-A3, wherein the request comprises a management plane (MP) request that requests one or more of:
to configure the waveform detection operational mode as one of inline and lookaside operation;
to receive a report of waveform detection capabilities; and
to receive a list of predefined identifiers for pulse and/or waveform types detectable by the network node.

Example A5. The network node of any one of Examples A1-A4, wherein one or more of:
the request comprises a control plane (CP) request that requests to configure and/or receive from the network node waveform parameters comprising at least one of a power threshold value, pulse and/or chirp characteristics, pulse meta data, event data and a detection probability value; and
the request and/or the response indicates at least one of: a predefined identifier of a pulse and/or a waveform type, a trigger detection event, a timestamp for the detection, a detection event notification and an identifier of a type of waveform analysis.

Example A6. The network node of any one of Examples A1-A5, wherein the request comprises a user plane (UP) request that requests an IQ sample.

Example B1. A method implemented in a network node configured to provide an application programming interface (API), the method comprising:
receiving from an application a request for information related to a waveform detection using an application programming interface (API); and
replying to the request with a response comprising the information related to the waveform detection.

Example B2. The method of Example B1, further comprising:
detecting a radar transmission and providing the information related to the radar detection to the application using the API;
detecting a Wi-Fi transmission and providing the information related to the Wi-Fi waveform detection to the application using the API; and/or
detecting a 3GPP LTE/NR transmission and providing the information related to the 3GPP LTE/NR waveform detection to the application using the API.

Example B3. The method of any one of Examples B1 and B2, wherein one or more of:
the network node is comprised in a base station/radio access network; and
the application using the API comprises at least one of a radio TRX function, a baseband processing function (BPF), a radio unit (RU), a distributed unit (DU) and a digital L1 lower PHY function comprised in a base station/radio access network.

Example B4. The method of any one of Examples B1-B3, wherein the request comprises a management plane (MP) request that requests one or more of:
to configure the waveform detection operational mode as one of inline and lookaside operation;
to receive a report of waveform detection capabilities; and
to receive a list of predefined identifiers for pulse and/or waveform types detectable by the network node.

Example B5. The method of any one of Examples B1-B4, wherein one or more of:
the request comprises a control plane (CP) request that requests to configure and/or receive from the network node waveform parameters comprising at least one of a power threshold value, pulse and/or chirp characteristics, pulse meta data, event data and a detection probability value; and
the request and/or the response indicates at least one of: a predefined identifier of a pulse and/or a waveform type, a trigger detection event, a timestamp for the detection, a detection event notification and an identifier of a type of waveform analysis.

Example B6. The method of any one of Examples B1-B5, wherein the request comprises a user plane (UP) request that requests an IQ sample.

Example C1. A network node configured to communicate with a wireless device (WD) and to provide an application programming interface (API), the network node configured to, and/or comprising a radio interface and/or a communication interface and/or processing circuitry configured to:
send from an application a request for information related to a waveform detection using an application programming interface (API); and
receive a reply to the request with a response comprising the information related to the waveform detection.

Example C2. The network node of Example C1, wherein one or more of:
the network node and/or radio interface and/or a communication interface and/or processing circuitry configured to determine whether to cease, start and/or continue transmission on frequencies that the waveform is detected on;
the information comprised in the response is related to a radar detection;
the information comprised in the response is related to a Wi-Fi waveform detection; and/or
the information comprised in the response is related to a 3GPP LTE/NR waveform detection.

Example C3. The network node of any one of Examples C1 and C2, wherein one or more of:
the network node is comprised in a base station/radio access network; and
the application using the API comprises at least one of a radio TRX function, a baseband processing function (BPF), a radio unit (RU), a distributed unit (DU) and a digital L1 lower PHY function comprised in a base station/radio access network.

Example C4. The network node of any one of Examples C1-C3, wherein the request comprises a management plane (MP) request that requests one or more of:
to configure the waveform detection operational mode as one of inline and lookaside operation;
to receive a report of waveform detection capabilities; and
to receive a list of predefined identifiers for pulse and/or waveform types detectable by the network node.

Example C5. The network node of any one of Examples C1-C4, wherein one or more of:
the request comprises a control plane (CP) request that requests to configure and/or receive from the network node waveform parameters comprising at least one of a power threshold value, pulse and/or chirp characteristics, pulse meta data, event data and a detection probability value; and
the request and/or the response indicates at least one of: a predefined identifier of a pulse and/or a waveform type, a trigger detection event, a timestamp for the detection, a detection event notification and an identifier of a type of waveform analysis.

Example C6. The network node of any one of Examples C1-C5, wherein the request comprises a user plane (UP) request that requests an IQ sample.

Example D1. A method implemented in a network node, the method comprising:
sending from an application a request for information related to a waveform detection using an application programming interface (API); and
receiving a reply to the request with a response comprising the information related to the waveform detection.

Example D2. The method of Example D1, wherein one or more of:
the method further comprises determining whether to cease, start and/or continue transmission on frequencies that the waveform is detected on;
the information comprised in the response is related to a radar detection;
the information comprised in the response is related to a Wi-Fi waveform detection; and/or
the information comprised in the response is related to a 3GPP LTE/NR waveform detection.

Example D3. The method of any one of Examples D1 and D2, wherein one or more of:
the network node is comprised in a base station/radio access network; and
the application using the API comprises at least one of a radio TRX function, a baseband processing function (BPF), a radio unit (RU), a distributed unit (DU) and a digital L1 lower PHY function comprised in a base station/radio access network.

Example D4. The method of any one of Examples D1-D3, wherein the request comprises a management plane (MP) request that requests one or more of:
to configure the waveform detection operational mode as one of inline and lookaside operation;
to receive a report of waveform detection capabilities; and
to receive a list of predefined identifiers for pulse and/or waveform types detectable by the network node.

Example D5. The method of any one of Examples D1-D4, wherein one or more of:
the request comprises a control plane (CP) request that requests to configure and/or receive from the network node waveform parameters comprising at least one of a power threshold value, pulse and/or chirp characteristics, pulse meta data, event data and a detection probability value; and
the request and/or the response indicates at least one of: a predefined identifier of a pulse and/or a waveform type, a trigger detection event, a timestamp for the detection, a detection event notification and an identifier of a type of waveform analysis.

Example D6. The method of any one of Examples D1-D5, wherein the request comprises a user plane (UP) request that requests an IQ sample.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| CPRI | Common Public Radio Interface |
| CUS | Control, User and Synchronization (planes) |
| DES | Dynamic Frequency Selection |
| KDB | Knowledge Database |
| LLS | Lower Layer Split |
| MP | Management Plane |
| NR-U | NR-Unlicensed (NR operating in unlicensed spectrum) |
| RD | Radar Detection |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A waveform detection interface between a wireless application and a waveform detector, the waveform detection interface comprising processing circuitry configured to:
exchange management plane information between the application and the waveform detector, the management plane information including capability information related to waveform detection;
exchange control plane information between the application and the waveform detector, the control plane information including configuration information related to a configuration of the waveform detector; and
exchange user plane information between the application and the waveform detector.

2. The waveform detection interface of claim 1, wherein the control plane information includes pulse configuration information to configure the waveform detector to detect a set of at least one pulse characteristic in a signal to be processed by the application.

3. The waveform detection interface of claim 2, wherein the at least one pulse characteristic includes at least one of a pulse width, a pulse-chirp frequency range and pulse power.

4. The waveform detection interface of claim 1, wherein the control plane information includes waveform configuration information to configure the waveform detector to detect a waveform characteristic.

5. The waveform detection interface of claim 4, wherein the waveform characteristic includes at least one of a number of bursts, burst duration and a number of pulses per burst.

6. The waveform detection interface of claim 1, wherein the user plane information includes event information concerning at least one of a pulse detection event and a waveform detection event, the event information including an indication of event detection confidence.

7. The waveform detection interface of claim 6, wherein the processing circuitry is further configured to perform post-processing of the event information.

8. The waveform detection interface of claim 7, wherein the post-processing includes at least one of a correlation of past event information with the event information and machine learning based at least in part on the event information.

9. The waveform detection interface of claim 1, wherein the user plane information includes an instruction to invoke the waveform detector.

10. The waveform detection interface of claim 1, wherein the user plane information includes I and Q sample information.

11. A method in a waveform detection interface between an application and a waveform detector, the method comprising:
exchanging management plane information between the application and the waveform detector, the management plane information including capability information related to waveform detection;
exchanging control plane information between the application and the waveform detector, the control plane information including configuration information related to a configuration of the waveform detector; and
exchanging user plane information between the application and the waveform detector.

12. The method of claim 11, wherein the control plane information includes pulse configuration information to configure the waveform detector to detect a set of at least one pulse characteristic in a signal to be processed by the application.

13. The method of claim 12, wherein the at least one pulse characteristic includes at least one of a pulse width, a pulse-chirp frequency range and pulse power.

14. The method of claim 11, wherein the control plane information includes waveform configuration information to configure the waveform detector to detect a waveform characteristic.

15. The method of claim 14, wherein the waveform characteristic includes at least one of a number of bursts, burst duration and a number of pulses per burst.

16. The method of claim 11, wherein the user plane information includes event information concerning at least one of a pulse detection event and a waveform detection event, the event information including an indication of event detection confidence.

17. The method of claim 16, wherein the processing circuitry is further configured to perform post-processing of the event information.

18. The method of claim 17, wherein the post processing includes at least one of a correlation of past event information with the event information and machine learning based at least in part on the event information.

19. The method of claim 11, wherein the user plane information includes an instruction to invoke the waveform detector.

20. The method of claim 11, wherein the user plane information includes I and Q sample information.
